(19) United States
(12) Patent Application Publication
(10) Pub. No.: US 2024/0103303 A1
(43) Pub. Date: Mar. 28, 2024

(54) ELECTRONIC CHARGING SYSTEM

(71) Applicant: Apple Inc., Cupertino, CA (US)

(72) Inventors: Alison B. Shutzberg, San Francisco, CA (US); Christopher W. Sarli, San Francisco, CA (US); Darshan R. Kasar, San Francisco, CA (US); Cameron A. Harder, San Francisco, CA (US); John Raff, Menlo Park, CA (US)

(21) Appl. No.: 18/460,367

(22) Filed: Sep. 1, 2023

Related U.S. Application Data
(60) Provisional application No. 63/376,753, filed on Sep. 22, 2022.

(51) Int. Cl. G02C 11/00; G02B 27/01; H02J 7/00; H02J 50/10; H02J 50/40

(52) U.S. Cl. CPC G02C 11/10; G02B 27/017; H02J 7/0044; H02J 50/10; H02J 50/402; G02B 2027/0178

(57) ABSTRACT

A wearable apparatus can include a head-mountable device that includes: a display, a display frame housing the display, arms connected to the display frame, a processor, and a battery electrically coupled to the processor. In addition, the wearable apparatus can include a wearable power device connectable to the battery of the head-mountable device when the head-mountable device is worn on a person or a clothing of the person.

### CROSS-REFERENCE TO RELATED APPLICATION(S)

This claims priority to U.S. Provisional Patent Application No. 63/376,753, filed 22 Sep. 2022, and entitled “Electronic Charging System,” the entire disclosure of which is hereby incorporated by reference.

### FIELD

The described embodiments relate generally to head-mountable devices. More particularly, the present embodiments relate to head-mountable devices and associated charging devices.

### BACKGROUND

Recent advances in portable computing have enabled head-mountable devices that provide augmented and virtual reality (AR/VR) experiences to users. Such head-mountable devices typically include various components such as a display, viewing frame, lens, battery, motor, speaker, and other components. These components can operate together to provide an immersive user experience.

These user experiences can vary in duration and usage intensity, which correlates with power consumption. Unfortunately, longer durations and/or more intense use sessions for head-mountable devices can dictate inconvenient charging (which is often unavailable “on the go”). Thus, conventional implementations of head-mountable devices and charging methods can inhibit wear of the head-mountable device throughout the day (or even throughout an entire session of use). Therefore, a head-mountable device capable of more use and improved, flexible charging configurations is desired.

### SUMMARY

In at least one example of the present disclosure, a wearable apparatus includes a head-mountable device that includes: a display, a display frame housing the display, arms connected to the display frame, a processor, and one or more batteries integrated within the head-mountable device (e.g., a battery electrically coupled to the processor). In addition, the wearable apparatus can include a wearable power device connectable to the battery of the head-mountable device when the head-mountable device is worn on a person or a clothing of the person.

In some examples, the wearable power device is attachable to at least one of the arms or a nose bridge of the display frame. In one example, the wearable apparatus further includes a power connection positioned at an arm tip region of at least one of the arms. In another example, the wearable power device includes a clip-on battery connectable to the power connection. In yet another example, the wearable power device includes: a rechargeable battery positionable against a neck or head of the person; and a lanyard connecting the rechargeable battery to the power connection. In a particular example, the power connection includes a conductive power connection. In one example, the wearable apparatus further includes: a first magnet positioned on or within at least one of the arms; and a second magnet positioned on or within the wearable power device. In certain implementations, the second magnet mates with the first magnet when the at least one arm is folded against the wearable power device. Further, in some examples, the clothing of the person is positionally secured between the first magnet and the second magnet.

In at least one example, an apparatus of the present disclosure includes augmented reality (AR) glasses that include: a display, a display frame housing the display, arms rotatably connected to the display frame, a processor disposed inside at least one of the arms, and a battery electrically coupled to the processor. The battery can be disposed inside at least one of the arms. The apparatus can further include a power device connectable to the AR glasses, where the AR glasses are at least partially exposed to an ambient environment when the power device is connected to the AR glasses, and where the power device is a rechargeable power device or an inductive power device.

In some examples, the power device includes: a rechargeable battery pack; and a tether electrically coupling the rechargeable battery pack to the AR glasses. In other examples, the power device includes a rechargeable case, the rechargeable case including: a charging interface; an exterior portion; and an interior portion sized shaped to receive the display frame and the display, wherein the arms are extendable out from the interior portion and foldable against the exterior portion. In certain implementations, the charging interface is positioned inside the rechargeable case. For example, the display frame includes a nose bridge, and the charging interface includes a conductive charging interface that is engageable with the nose bridge. As another example, at least one of the display or the display frame includes charging coils, and the charging interface includes an inductive charging interface that is engageable with the charging coils. In certain examples, the charging interface is positioned outside the rechargeable case, the charging interface including a power connection between the exterior portion and the arms. In particular examples, the power device includes an inductive charging dock, the inductive charging dock including a docking station, wireless charging pad, mobile phone device, tablet, or laptop.

In at least one example of the present disclosure, an apparatus of the present disclosure includes AR glasses that include: a display; a display frame housing the display; first and second arms connected to the display frame, the first arm including a detachable portion; and a battery disposed inside the detachable portion. The apparatus further includes a charging device sized and shaped to receive the detachable portion when detached from the first arm.

In certain examples, the second arm includes: an additional detachable portion, and an additional battery disposed inside the additional detachable portion. The apparatus can further include an additional detachable portion that is interchangeable with the detachable portion.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a side view of a head-mountable device worn on a user head.

FIG. 2 illustrates a schematic view of an example apparatus including a head-mountable device and a power device.

FIG. 3 illustrates an example of a head-mountable device including example conductive charging interfaces.

FIG. 4 illustrates an example apparatus including a head-mountable device and a wearable power device.

FIG. 5 illustrates another example apparatus including a head-mountable device and a wearable power device.

FIGS. 6A-6B illustrates yet another example apparatus including a head-mountable device and a wearable power device.

FIG. 7 illustrates an example apparatus including a head-mountable device and a rechargeable power device.

FIGS. 8A-8D illustrate examples of an apparatus including a rechargeable case and a head-mountable device.

FIG. 9 illustrates an example of a head-mountable device and a rechargeable battery pack tethered together.

FIG. 10 illustrates an example head-mountable device including detachable portions.

FIG. 11 illustrates an example apparatus including a head-mountable device and a charging dock.

FIGS. 12A-12B illustrate an example head-mountable device with charging coils for implementing with an inductive power device.

### DETAILED DESCRIPTION

Detail reference is made below to exemplary embodiments illustrated in the accompanying drawings. The descriptions that follow are not intended to limit the embodiments to one preferred embodiment. Rather, the following descriptions are intended to cover alternatives, modifications, and equivalents that can be included within the spirit and scope of the described embodiments as defined by the appended claims.

The following disclosure relates to apparatuses that include a head-mountable device and an associated charger. In a particular example, the apparatuses of the present disclosure include wearable chargers. For example, the wearable chargers disclosed herein are connectable to the battery of a head-mountable device when the head-mountable device is worn on a person or a clothing of the person. To illustrate, a wearable charger can directly attach (e.g., clip onto) one or more arms of the head-mountable device. As another example, a wearable charger can suspend (e.g., around a user's neck) and attach to the head-mountable device via a lanyard. In yet another example, a wearable charger can include a power device that helps secure the head-mountable device to clothing (e.g., a shirt, pant pocket, etc.) when charging the head-mountable device.

The apparatuses of the present disclosure also include charging cases that interface with a head-mountable device. For example, charging cases can include fully encompassing cases that enclose the head-mountable device inside. As another example, charging cases can include partial cases that partially expose arms or other portions of the head-mountable device while engaged. These or other cases can include rechargeable cases with inductive or conductive interfaces.

The apparatuses of the present disclosure can also include charging docks, such as charging stations, wireless charging pads, etc. A charging dock can similarly expose portions of the head-mountable device to the ambient environment during charging. Likewise, a charging dock can include inductive or conductive charging interfaces.

Other apparatuses are also disclosed herein. For example, a head-mountable device can be tethered to a non-wearable battery pack or a solar panel, as may be desired.

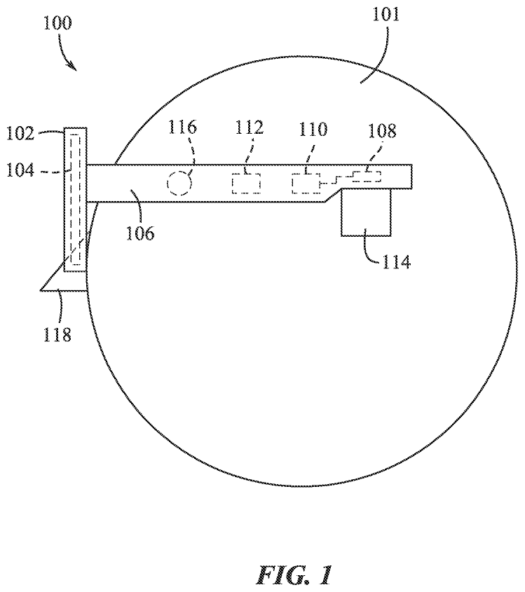

These and other embodiments are discussed below with reference to FIGS. 1-12B. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a side view of a user wearable system in the form of a head-mountable device 100 worn on a user head 101. The user wearable system can include any number of augmented reality (AR) glasses or virtual reality (VR) goggles. In some examples, the head mountable device can include a display frame 102 that houses a display 104. In particular, the display frame 102 can include a rim surrounding the display 104. In addition, the display frame 102 can include a nose bridge (where a “nose bridge” refers to a frame portion connecting left and right frame sides of the display frame 102). In certain examples, the nose bridge can include a nose cutout for resting on a nose 118 of the user.

The display 104 can further include one or more optical lenses or display screens positionable in front of the eyes 116 of the user. The display 104 can include a display for presenting a virtual reality visualization, an augmented reality visualization, or other suitable visualization.

Additionally shown in FIG. 1, the head-mountable device 100 can include arms 106 (albeit, only a single arm is seen in this figure view). The arms 106 can be rotatably connected to the display frame 102 and extend distally toward the rear of the head during use. The arms 106 are configured to secure the display 104 in a position relative to the user head 101 (e.g., such that the display 104 is maintained in front of a user's eyes 116). For example, the arms 106 extend over the user's ears 114. In certain examples, the arms 106 can rest on the user's ears 114 to secure the head-mountable device 100 via friction between the arms 106 and the user head 101. For example, the arms 106 can apply opposing pressures to the sides of the user head 101 to secure the head-mountable device 100 to the user head 101. Optionally, the arms 106 can be connected to each other via a strap (not shown) that can compress the head-mountable device 100 against the user head 101.

Further, the head-mountable device 100 can include various components inside one or more of the arms 106. For example, the head-mountable device 100 can include a battery 108. The battery 108 can include a myriad of different types of batteries or power sources. Indeed, the battery 108 can include one or more electrochemical cells with external connections for powering electrical devices or electrical components. For example, in some implementations, the battery 108 includes a lithium ion battery, alkaline battery, etc. In a specific example, the battery 108 includes a rechargeable battery. In other words, the battery 108 can be dispensable or rechargeable, as may be desired.

In particular examples, the battery 108 is electrically connected to a processor 110. The processor 110 can execute computer-executable instructions and/or cause various components of the head-mountable device 100 to perform certain tasks (e.g., cause the display 104 to present certain AR visualizations). The processor 110 can include one or more processors (e.g., a system on chip, integrated circuit, driver, microcontroller, application processor, crossover processor, etc.).

While the present system is described as including a battery, the battery 108 is but one example of a power supply. Other power supplies can also be used in a similar manner as the battery 108. As used herein, the term “power supply” refers to any power source that supplies power to charge or recharge the head-mountable device 100. For example, a power supply can include fuel cells, battery cells, generators, alternators, solar power converters, motion-based converters (e.g., that convert vibrations or oscillations into power), etc. In particular implementations, a power supply can convert alternating current to direct current (or vice-versa) for charging or recharging the head-mountable device 100. Some particular examples of a power supply can include a switched mode power supply, an uninterruptible power supply, an alternating current power supply, a direct current power supply, a regulated power supply, a programmable power supply, a computer power supply, and a linear power supply. For ease of explanation, the present system will be described in the context of a battery 108 as the power supply.

The head-mountable device 100 can also include other components. For instance, the head-mountable device 100 can include a microphone, a speaker, a printed circuit board, etc. In certain implementations, the head-mountable device 100 includes a speaker 112. The speaker 112 can generate audible sound or vibrational sound (via bone conduction). In at least some examples, the speaker 112 can include a magnet, which can be leveraged for certain charging configurations discussed below in relation to subsequent figures.

The display frame 102 and the arms 106 can include a variety of different materials. In some examples, the display frame 102 and the arms 106 can include a rigid material (e.g., metal) to provide increased support, protect certain internal components from undesired stresses or strain, etc. Additionally or alternatively, the display frame 102 and the arms 106 can include a flexible, softer material (e.g., silicone) to provide enhanced flexibility and comfort, particularly at areas prone to contact a human head.

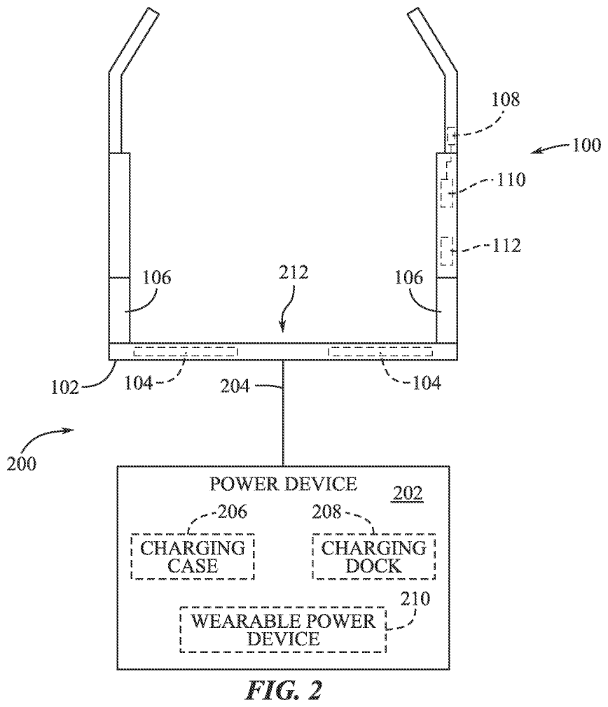

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1. The following section discusses various aspects of a power device, mentioned above. Specifically, FIG. 2 illustrates a schematic view of an apparatus 200 including the head-mountable device 100 and a power device 202 in accordance with one or more examples of the present disclosure.

As shown in FIG. 2, the power device 202 is connected to the head-mountable device 100 via a power connection 204. As used herein, the term “power connection” refers to an electrical connection. In particular, a power connection can include a wired or wireless charging interface (e.g., coupling) that allows the transfer of power from the power device 202 to the head-mountable device 100. For example, a power connection can include a conductive connection (e.g., an electromechanical connection with mated pins, prongs, plugs, socket connectors, or other suitable mechanical contacts that are electrically conductive). In addition, example components of a power connection include switches, relays, diodes, transistors, resistors, capacitors, transformers, amplifiers, fuses, inductors, potentiometers, etc. Still, in other examples, a power connection can include an inductive connection (e.g., that provides the transfer of power via induction).

The power connection 204 is depicted schematically. Accordingly, the power connection 204 can include a myriad of different positions for interfacing the head-mountable device 100 and the power device 202. Indeed, the power connection 204 can connect the power device 202 and the display frame 102 (e.g., at a nose bridge 212). In another example, the power connection 204 can connect at least one of the arms 106 and the power device 202. In these or other examples, the power connection 204 can electrically couple the power device 202 with the battery 108 specifically.

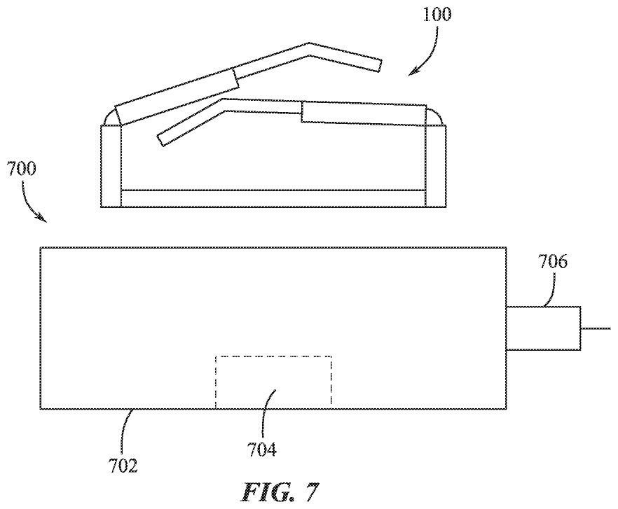

Further shown, the power device 202 can include a variety of different types of devices. For example, the power device 202 can include at least one of a charging case 206, a charging dock 208, or a wearable power device 210. As used herein, the terms “charging case,” “case,” or “rechargeable case” refer to an enclosure (e.g., a partial enclosure) sized and shaped to receive a portion of the head-mountable device 100 and provide power thereto. Some particular examples of the charging case 206 are described below with reference to FIGS. 7, 8A-8D and FIG. 10.

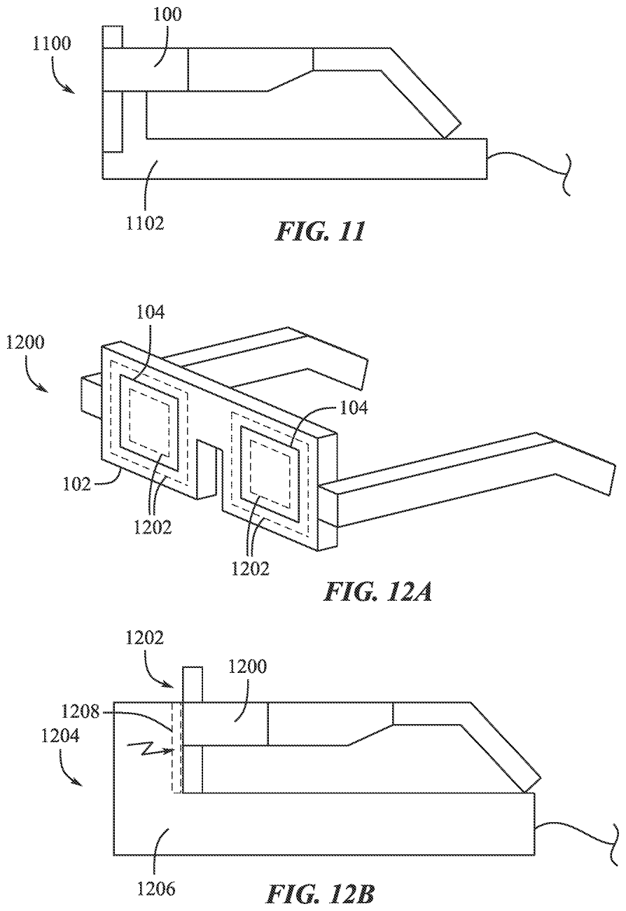

The power device 202 can also include a charging dock 208. As used herein, the term “charging dock” refers to at least one of a designated charging area or a client device that can provide or share power. One example of a designated charging area includes a wireless charge pad, stand, or mount—often compatible with a desk, vehicle console, etc. Some examples of a client device include a smartphone, a tablet, a smart television, a desktop computer, a laptop computer, a virtual reality device, an augmented reality device, a smart watch, a sound/speaker device, a camera device, or other computing device. In these or other examples, the charging dock provides power to the head-mountable device 100 when the head-mountable device 100 is positioned in close proximity to, or in direct contact with, the charging dock 208. Some particular examples of the charging dock 208 are described below in relation to FIGS. 11-12B.

The power device 202 can further include a wearable power device 210. As used herein, the term “wearable device” or “wearable power device” refers to a portable battery pack that can be attached to the head-mountable device 100 when worn (e.g., when donned on a user head or attached to clothing). A wearable power device is therefore compatible with the head-mountable device 100 when positioned in front of a user's eyes, when resting on the top of a user head (or ball cap), or when hanging from a shirt neckline, pant pocket—to name a few examples. Some particular implementations of a wearable power device are described below in relation to FIGS. 4-6B.

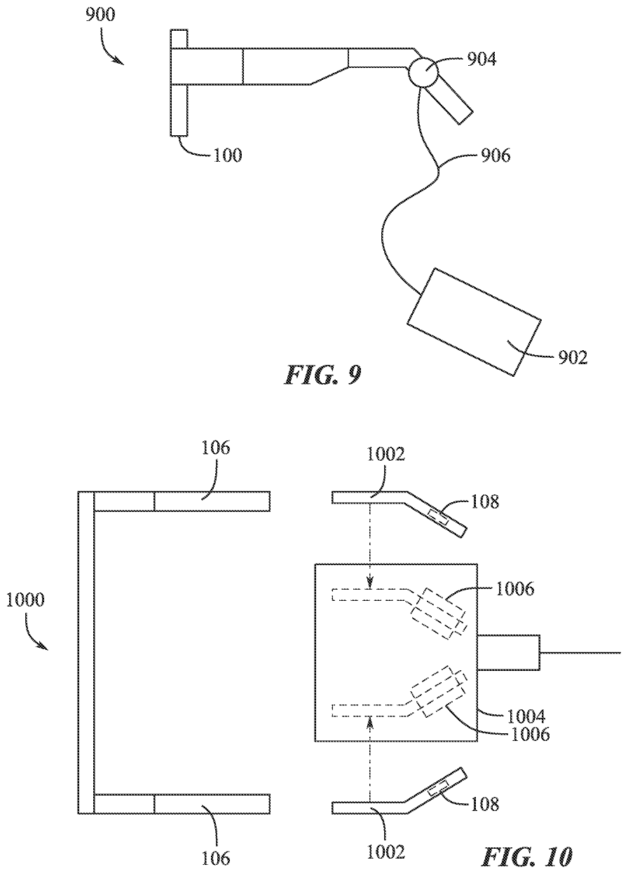

The power device 202 can also include other types of devices that are not expressly illustrated. For example, the power device 202 can include non-wearable devices, such as a battery or other charging brick that may be too large or heavy to wear. One particular implementation of such a device includes a battery puck and a tether (as described below in relation to FIG. 9).

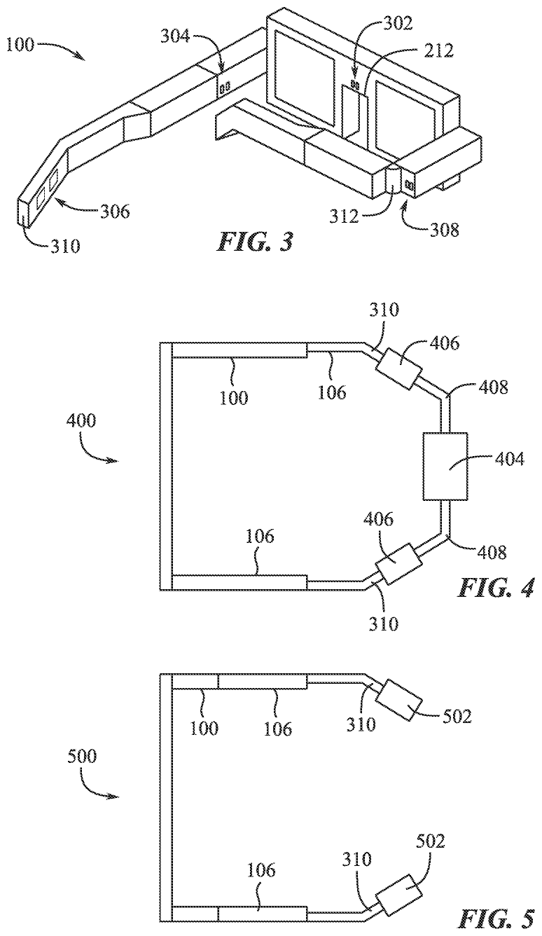

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2. The following section discusses example charging interfaces, mentioned above. Specifically, FIG. 3 illustrates an example of the head-mountable device 100 including example conductive charging interfaces in accordance with one or more examples of the present disclosure.

As shown in FIG. 3, the head-mountable device 100 can include a nose bridge interface 302. The nose bridge interface 302 can be positioned between lenses of the display (e.g., at a middle portion of the head-mountable device 100). Additionally, the head-mountable device 100 can include a temple interface 304. The temple interface 304 is positioned between an arm tip 310 (e.g., an end portion) and an arm hinge 312 that mates the arm 106 and the display frame 102. The temple interface can correspond to the anatomical region of a human head between an eye and an ear.

The head-mountable device 100 can further include an arm tip interface 306 positioned at the arm tip 310. Additionally or alternatively, the head-mountable device can include a hinge interface 308 positioned at the arm hinge 312.

In some examples, the head-mountable device 100 can include each of the foregoing charging interfaces, only a single charging interface, or a particular combination of charging interfaces selected from the foregoing. Additionally, one or more of the foregoing charging interfaces can flexibly provide a variety of implementations with a power device of the present disclosure (as will be demonstrated further below).

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

The following sections in relation to FIGS. 4-6B describe various examples of wearable power devices. In particular, FIG. 4 illustrates an apparatus 400 including the head-mountable device 100 and a wearable power device in accordance with one or more examples of the present disclosure.

As shown in FIG. 4, the wearable power device includes a rechargeable battery 404 coupled to the arm tip 310 of the arms 106. In some examples, the rechargeable battery 404 is positionable against a back of a neck or user head (or against longer hair). In these or other examples, the rechargeable battery 404 can include a pad (e.g., a cushion pad, a thermal blocking pad, etc.) for enhanced comfort of the rechargeable battery 404 against user skin. In this manner, the rechargeable battery 404 can be worn while the head-mountable device 100 is in-use or donned on a user head.

To facilitate this wearable configuration, the rechargeable battery 404 couples to the arm tip 310, or the general arm tip region, of the arms 106 via a power connection 406 and a lanyard 408. In some examples, the power connection 406 includes an electromechanical connection (e.g., a magnetic, pogo pin connection). Additionally or alternatively, the power connection 406 is removably attachable to the arm tip 310 of the arms 106. For instance, the power connection 406 can include clasps, hooks, or other locking mechanisms to secure the lanyard 408 and the rechargeable battery 404 to the head-mountable device 100.

Power can transfer along one or more electrical wires disposed inside the lanyard 408. Different wire gauges can provide different levels and/or rates of power transfer. Further, in some examples, the lanyard 408 is shielded (e.g., thermally shielded for comfort).

In at least some examples, the lanyard 408 can be adjustable. For example, the lanyard 408 can be loosened or tightened to adjust a position of the rechargeable battery 404. As another example, the lanyard 408 can be adjusted to provide different levels of tightness and/or accommodate different head sizes. In yet another example, the lanyard 408 can include an outer sheath defining different colors or aesthetic designs, as may be desired.

Any of the features, components, and/or parts, including the arrangements and configurations thereof shown in FIG. 4, can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4. Additional details of a head-mountable device and an associated power device are provided below with reference to FIG. 5.

FIG. 5 illustrates an apparatus 500 including the head-mountable device 100 and a wearable power device 502 in accordance with one or more embodiments of the present disclosure. As shown, the wearable power device 502 includes a rechargeable battery attachable to the arms 106 at each arm tip 310. In particular, the attachable battery (i.e., the wearable power device 502) can attach to a power connection at each arm tip 310. For example, the attachable battery can attach to the power connection at the arm tip 310 via a clip-on attachment, magnetic attachment, press-fit attachment, interlocking attachment, etc. In turn, the attachable battery can be detached from the power connection at the arm tip 310 via a pulling motion, twisting motion, push-pull combination of motions, a button-press, or other suitable release methods.

In some examples, the wearable power device 502 is lightweight and ergonomic—positionable adjacent to or abutting the user skin behind the ears. Additionally or alternatively, the wearable power device 502 is shaped or contoured to follow the profile of the arm tip 310. In certain implementations, the wearable power device 502 can also avoid pressure points against the user head. For instance, the wearable power device 502 can be oriented or shaped relative to the arm tip 310 such that the wearable power device 502 is positioned parallel to a user head or positioned away from the user head (rather than inward and towards a user head to create a pressure point). In these or other examples, the arm tip 310 can be flexible to also help avoid a pressure point at the wearable power device 502.

In some examples, albeit not shown, the wearable power device 502 is connected to a single arm 106 (rather than both arms 106 as discussed above). In such a case, a single clip-on battery as the wearable power device 502 can power a single HMD battery in the corresponding arm, or multiple HMD batteries throughout the head-mountable device 100 (including an additional HMD battery in the other arm 106 that does not have a wearable power device 502).

In other alternative embodiments, the wearable power device 502 is connectable with any charging interface or power connection of the present disclosure. For example, the wearable power device 502 can connect to at least one of a nose bridge interface, a temple interface, an arm hinge interface, etc. in the same or similar ways as discussed above.

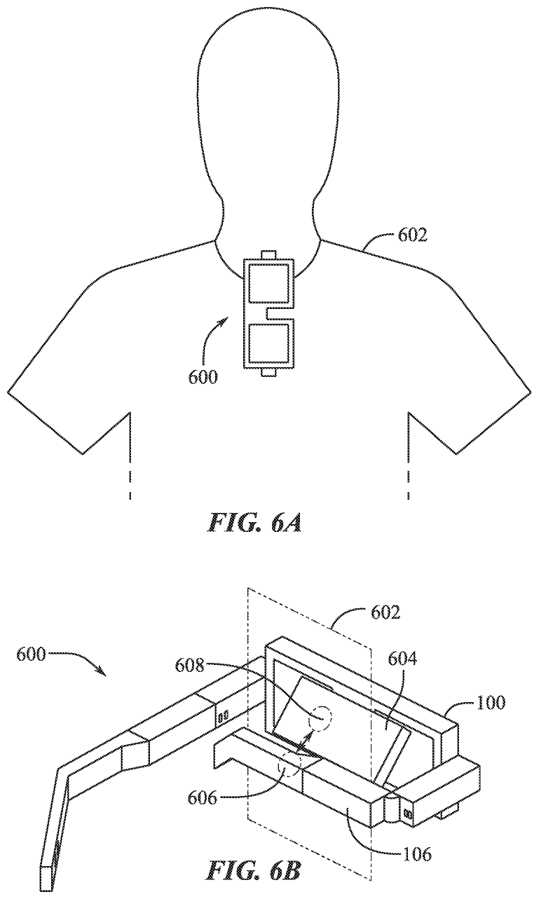

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5. Additional examples of head-mountable devices with associated power devices are provided below with reference to FIGS. 6A-6B.

FIGS. 6A-6B illustrate an apparatus 600 including the head-mountable device 100 and a power device 604 in accordance with one or more examples of the present disclosure. As shown in FIG. 6A, the apparatus 600 is being worn on clothing 602—namely from the neckline of a shirt. However, this configuration of wearing the apparatus 600 can be modified as may be desired. For example, the apparatus 600 can be worn atop a ball cap or clipped to a pant pocket or belt. As another example, the apparatus 600 can be worn off-person (e.g., on a backpack, briefcase, or purse). In this manner, the apparatus 600 can provide a convenient way of charging the head-mountable device 100 during use breaks or session pauses to facilitate further (e.g., all day) use.

In these or other examples, the apparatus 600 can be positionally secured to the clothing 602 (e.g., without falling or slipping off from the clothing 602). To do so, the apparatus 600 implements a particular securement configuration that leverages the arm foldability of the head-mountable device 100. Specifically, as shown in FIG. 6B, the power device 604 can connect to a nose bridge interface of the head-mountable device 100—thereby mounting the power device 604 to the head-mountable device 100 in a charging state. In turn, one of the arms 106 can fold towards the head-mountable device 100 and against the power device 604. In doing so, a magnet 606 positioned on or within the arm 106 can mate with a magnet 608 positioned on or within the power device 604. Once the magnet 606 and the magnet 608 mate with each other, the clothing 602 is secured between the mating magnets. Thus, the power device 604 can conveniently charge the head-mountable device 100 while the head-mountable device 100 is being worn on the clothing 602.

In alternative examples, the power device 604 connects with a power connection other than at the nose bridge. For example, the power device 604 connects with a power connection in the arm 106 when folded against the power device 604. In certain implementations, the power device 604 can be anchored to the nose bridge of the head-mountable device 100 via corresponding magnets (e.g., for additional support or rigidity). Additionally or alternatively, the arms 106 can include corresponding magnets to secure the clothing 602 between the arms 106.

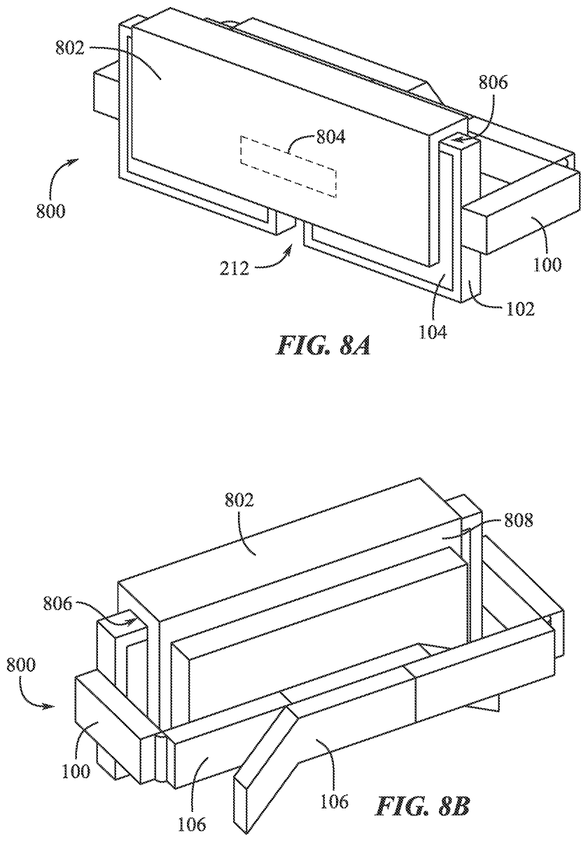

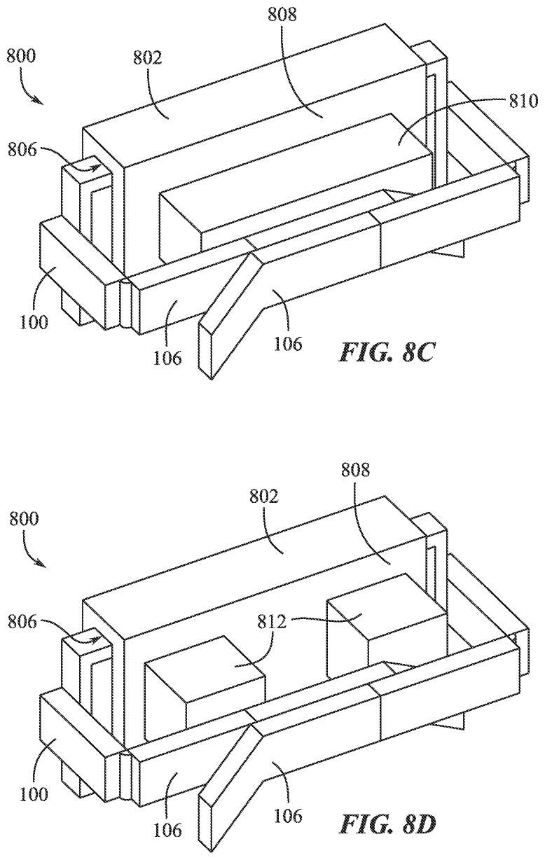

Any of the features, components, and/or parts, including the arrangements and configurations thereof shown in FIG. 6A can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6B. Examples of charging cases are provided below with reference to FIGS. 7-8D.

The following description in relation to FIGS. 7-8D discusses various example charging cases. In particular, FIG. 7 illustrates an apparatus 700 including the head-mountable device 100 and a rechargeable power device 702 in accordance with one or more examples of the present disclosure.

As shown, the rechargeable power device includes a charging case, namely a rechargeable case 702. In some examples, the rechargeable case 702 is a fully enclosed charging case that is sized and shaped to totally encompass the head-mountable device 100 when inserted therein. Further, in some examples, the rechargeable case 702 includes a charging interface 704 inside the enclosure of the rechargeable case 702. For instance, the charging interface 704 can include a conductive charging interface, such as a nose bridge interface, arm hinge interface, or arm tip interface.

Additionally shown, the rechargeable case 702 can be recharged via a power connection 706. In some examples, the power connection 706 can couple a power source (e.g., a 120 Vac wall socket, battery, etc.) to the charging interface 704 of the rechargeable case 702.

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7.

The following description discusses other types of charging cases, including partially enclosed charging cases that leave the head-mountable device at least partially exposed to an ambient environment. In particular, FIGS. 8A-8D illustrate examples of an apparatus 800 including a power device 802 and the head-mountable device 100 in accordance with one or more examples of the present disclosure.

As shown, the apparatus 800 includes a power device 802. The power device 802 can include a rechargeable power device—configured for repeated charge and discharge cycles. The power device 802 can also include a charging interface 804. In some examples, the charging interface 804 is positioned within an interior portion 806, which includes an internal volume defined by the interior cover surfaces of the power device 802. For instance, the charging interface 804 includes a conductive charging interface or an inductive charging interface positioned within the interior portion 806. In a specific implementation, the charging interface 804 is engageable (e.g., for power transfer via conductive contact) with the nose bridge 212 of the head-mountable device 100. In alternative implementations, the charging interface 804 is engageable (e.g., for power transfer via induction) with one or more charging coils disposed within the head-mountable device 100. Example charging coils are discussed more below in relation to FIGS. 12A-12B.

In some examples, the power device 802 at least partially covers the display frame 102 and the display 104 within the interior portion 806. In certain examples, the power device 802 entirely covers the display frame 102 and the display 104 within the interior portion 806 (but not other portions of the head-mountable device 100). For instance, the power device 802 can wrap completely around the display frame 102 and the display 104.

Additionally, in some examples, the power device 802 includes sides through which the arms 106 of the head-mountable device 100 can extend out from the interior portion 806 and fold back against an exterior portion 808 of the power device 802. In certain implementations (shown in FIGS. 8A-8D), the sides of the power device 802 are fully open (thereby allowing the head-mountable device 100 to be slid into and out of the power device 802). In this example implementation, the arms 106 extend out from the interior portion 806 through the open sides of the power device 802. In other implementations, the sides of the power device 802 include holes, apertures, or slots that are sized and shaped for the arms 106 to be inserted through and extend out from the interior portion 806.

FIGS. 8C-8D illustrate alternative examples of charging interfaces for the power device 802. In particular, FIGS. 8C-8D show the power device 802 includes a charging interface positioned on the exterior portion 808. In FIG. 8C, a charging interface 810 is positioned along the exterior portion 808 across the backside of the power device 802. In some examples, the charging interface 810 includes a single power connection (e.g., a conductive power connection). In particular examples, the single power connection is centered laterally across the charging interface 810 so that either of the arms 106 can engage the charging interface 810. In other examples, the charging interface 810 includes symmetrical power connections across the charging interface 810 (e.g., a left-side connection for the left arm and a right-side connection for the right arm). Thus, the charging interface 810 can engage either of the arms 106, depending on which arm 106 is folded first. Still, in other examples, multiple power connections of the charging interface 810 can engage a single arm (e.g., at an arm tip interface and a temple interface).

Similarly, FIG. 8D shows the power device 802 includes charging interfaces 812. Unlike the single charging interface 810 in FIG. 8C, the charging interfaces 812 of FIG. 8D are positioned symmetrically along the exterior portion 808 of the backside of the power device 802. Each of the charging interfaces 812 can include power connections (whether conductive or inductive) to engage either a first arm or a second arm of the arms 106, depending on which is folded first. In some cases, both of the charging interfaces 812 engage a single arm 106 (e.g., at an arm tip interface and a temple interface). In other implementations, only one of the charging interfaces 812 engage a single arm 106 (e.g., a left-side connection for the left arm and a right-side connection for the right arm).

In these or other examples, the power device 802 just described in relation to FIGS. 8A-8D can include a variety of different materials. In some examples, the power device 802 includes a rigid material. In one example, the power device 802 includes a flexible, soft material (e.g., silicone). In particular examples, the power device 802 includes a combination of both rigid and soft materials. For instance, the power device 802 can be rigid at regions corresponding to the display 104 (e.g., to protect the display 104). In another example, the power device can be rigid at regions corresponding to the charging interfaces (e.g., to support the battery and/or conductive contacts). Additionally or alternatively, other areas of the power device 802 can be flexible (e.g., to promote easy storage or pocketing of the apparatus 800).

Any of the features, components, and/or parts, including the arrangements and configurations thereof shown in FIGS. 8A-8D can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 8A-8D.

The following section discusses tethered type power devices for charging the head-mountable device 100. In particular, FIG. 9 illustrates an apparatus 900 including the head-mountable device 100 and a power device 902 in accordance with one or more examples of the present disclosure. In certain implementations, the power device 902 includes a rechargeable battery pack. In other implementations, the power device 902 includes a portable solar panel.

As shown, the power device 902 is coupled to the head-mountable device 100 via a power connection 904 (e.g., at an arm tip 310 of the arms 106). The power connection 904 can include a variety of different connections (whether conductive or inductive), as described above. For instance, the power connection 904 can include a lightning connection, micro-USB connection, or a USB-C connection. In some examples, the power device 902 is electrically coupled to the power connection 904 via a tether 906. In certain examples, the tether 906 is adjustable in length. The tether 906 can also include a variety of different gauge wire (e.g., for different types of power connections or rates of power transfer to the head-mountable device 100).

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9.

The following section discusses a head-mountable device with a detachable portion that can be charged in a charging device. In particular, FIG. 10 illustrates a head-mountable device 1000 including detachable portions 1002 in accordance with one or more examples of the present disclosure. The head-mountable device 1000 is similar to the head-mountable device 100 discussed above, except the head-mountable device 1000 includes a variation of the arms 106 with detachable portions (i.e., detachable portions 1002).

In particular examples, the detachable portions 1002 include a segment of the arms 106 that are removably attachable relative to the head-mountable device 1000. For instance, the detachable portions 1002 can include arm tips that can be removed from and reattached to the head-mountable device 1000. To illustrate, the detachable portions 1002 can be removably attached to the arms 106 via a magnetic connection, interlocking connection, electro-mechanical connection, etc.

As shown, the detachable portions 1002 can be detached from the arms 106 and inserted into a charging device 1004 that is sized and shaped to receive at least one of the arms 106. In some examples, the charging device 1004 includes a rechargeable case. For instance, the charging device 1004 includes a charging interface 1006 that is positioned inside the charging device 1004 to transfer power from a rechargeable case battery of the charging device 1004 to the arm battery (i.e., the battery 108) in the arms 106. Additionally or alternatively, the charging device 1004 includes a charging interface 1006 that is positioned inside the charging device 1004 to transfer power to the arm battery (i.e., the battery 108) in the arms 106 from a power supply, such as a 120 Vac wall socket connected to the charging device 1004. Thus, the charging device 1004 can include one or more power supply ports for connections to a power supply that can charge, recharge, or otherwise power the charging device 1004. In certain implementations, the charging device 1004 can include a battery (e.g., a rechargeable battery) disposed within the body of the charging device 1004 that can charge the detachable portions 1002 without a connection to an external power supply. The battery can be connectable to the charging interface 1006. In these or other examples, the charging interface 1006 is an inductive interface or a conductive interface.

In some examples, a single detachable portion 1002 can be charged in the charging device 1004. In other examples, both detachable portions 1002 can be charged (e.g., simultaneously charged) in the charging device 1004. In these or other examples, an additional detachable portion (e.g., a charged detachable portion) can be swapped or interchanged with a detachable portion that needs to be charged. For instance, a third detachable portion can be attached to one of the arms 106 to replace a first detachable portion with a dead battery. The third detachable portion can include a charged battery that can power the head-mountable device 1000. In some examples, the third detachable portion can operably power the head-mountable device 1000 despite a second detachable portion (still attached to the head-mountable device 1000) also including a dead battery. In other examples, two functioning batteries (i.e., the battery 108 in each of the detachable portions 1002) is needed for operation of the head-mountable device 1000. In this manner, the battery 108 in the detachable portions 1002 can be charged in a flexible, convenient manner that can facilitate longer durations of wearing the head-mountable device 1000.

It will be appreciated by those of ordinary skill in the art that one or more of the detachable portions 1002 need not have a battery 108. For example, the detachable portions 1002 can include different types of arm tips to address ergonomic solutions. To illustrate, the detachable portions 1002 can be swapped out for other detachable portions that have foam, gel, or other desired material (e.g., for added comfort). As another example, the detachable portions 1002 can be swapped out for other detachable portions that have a different contour, level of flex or rigidity, etc. (e.g., to fit a different head size).

Any of the features, components, and/or parts, including the arrangements and configurations thereof shown in FIG. 10 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 10.

The following sections discuss various examples of a power device that includes a charging dock. In particular, FIG. 11 illustrates an apparatus 1100 including the head-mountable device 100 and a charging dock 1102 in accordance with one or more examples of the present disclosure.

As used herein, the term “charging dock” refers to a docking station, wireless charging pad, mobile phone device, tablet, or laptop. In particular implementations, a charging dock includes a structure, platform, or port upon which at least a portion of the head-mountable device 100 can rest. In some examples, a charging dock (such as a wireless charging pad or docking station) itself is not rechargeable, but instead is directly connected to a power source, like a 120 Vac wall socket. In other examples, a charging dock is rechargeable and corresponds to a device from which power is shared or scavenged, such as a mobile phone device, tablet, or laptop. A charging dock can also provide power to the head-mountable device 100 via conductive or inductive charging interfaces, as described above.

As shown, the charging dock 1102 includes a docking station in the form of a charging stand. In particular implementations, the charging dock 1102 includes a conductive charging interface. For instance, the charging dock 1102 includes a nose bridge interface that engages with a nose bridge of the head-mountable device 100.

The charging dock 1102, albeit portable, can be configured for sitting atop a desk or other suitable surface (e.g., for directly plugging into a power supply). By utilizing a direct power supply, the charging dock 1102 is always ready for charging the head-mountable device 100. In at least some examples, the charging dock 1102 includes a battery (e.g., a rechargeable battery) in electrical communication with the charging coils and/or a power supply port.

Any of the features, components, and/or parts, including the arrangements and configurations thereof shown in FIG. 11 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 11.

By contrast, FIGS. 12A-12B illustrate a head-mountable device 1200 with charging coils 1202 for implementing with an inductive power device in accordance with one or more examples of the present disclosure. As shown, the head-mountable device 1200 includes the charging coils 1202. In some examples, the charging coils 1202 are disposed on the head-mountable device 1200 (e.g., at least partially above a frame surface or display surface). In other examples, the charging coils 1202 are disposed within the head-mountable device 1200 (e.g., subsurface). In certain implementations, the charging coils 1202 are positioned within the display 104. Additionally or alternatively, the charging coils 1202 are positioned within the display frame 102 and outside of the display 104. In particular implementations, the charging coils 1202 are invisible to the unaided human eye.

As used herein, an “unaided human eye” is a naked eye of an average human observer having regular vision and that is not augmented or supplemented by lenses, microscopes, cameras, or other scopes or equipment used to discern physical matter beyond the natural human eye.

In these or other examples, the charging coils 1202 can include wire of various materials. For instance, the charging coils 1202 can include wire formed of copper, aluminum, nickel, steel, brass, iron, graphite, carbon, silicon carbide, or suitable combinations thereof.

Moreover, it will be appreciated by those of ordinary skill in the art that the charging coils 1202 can include additional wiring and/or electrical components to electrically connect to the HMD battery (e.g., the battery 108, not illustrated). Additionally or alternatively, the charging coils 1202 includes additional wiring and/or electrical components, such as multiple coils and/or multiple layers of windings, as may be desired.

As shown in FIG. 12B, an apparatus 1204 includes the head-mountable device 1200 and an inductive charging dock 1206. The inductive charging dock 1206 can include one or more charging coils 1208 to be positioned in parallel with (and in close proximity) to the charging coils 1202. For example, the one or more charging coils 1208 of the inductive charging dock 1206 are positionable within about 1 mm to about 30 mm of the charging coils 1202 when the head-mountable device 1200 is mounted on the inductive charging dock 1206. The inductive charging dock 1206 can then generate an alternating electromagnetic field via the one or more charging coils 1208. In turn, the charging dock 1206 can inductively transfer energy to the charging coils 1202 in the head-mountable device 1200.

Further, the inductive charging dock 1206, albeit portable, can be configured for sitting atop a desk or other suitable surface (e.g., for directly plugging into a power source). By utilizing a direct power source, the inductive charging dock 1206 is always ready for charging the head-mountable device 1200.

Any of the features, components, and/or parts, including the arrangements and configurations thereof shown in FIGS. 12A-12B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 12A-12B.

In some examples, the present systems and methods can provide customized and adaptive experiences for the user by the collection, use, storage, and/or transmission of personal information data. However, if such personal information data is used, it should only be used, collected, stored, and/or transmitted in accordance with well recognized and accepted best practices intended to prevent unauthorized access or use of the personal information data. In some examples the personal information data used can be anonymized to prevent such unauthorized access. However, the present exemplary systems and methods can be practiced without the use, collection, storage, and/or transmission of personal information data.

Some example features of an example charging case as detailed above (e.g., for detachable arm tips of a head-mountable device) can include:

1. A charging case, comprising:
a case body sized and shaped to receive at least one detachable arm tip of augmented reality (AR) glasses; and
a charging interface positioned inside the case body, the charging interface configured for transferring power to the at least one detachable arm tip of the AR glasses.

2. The charging case of claim 1, wherein the charging interface is an inductive charging interface.

3. The charging case of claim 1, wherein the charging interface is a conductive charging interface.

4. The charging case of claim 1, further comprising a rechargeable battery electrically coupled to the charging interface.

5. The charging case of claim 4, further comprising a power supply port electrically coupled to at least one of the charging interface or the rechargeable battery.

Similarly, some example features for an example charging dock (e.g., an inductive charging dock for a head-mountable device) can include:

6. An inductive charging dock, comprising:
a stand body; and
a charging coil disposed within the stand body, the charging coil having a size and orientation for inductive power communication with augmented reality (AR) glasses.

7. The inductive charging dock of claim 6, further comprising a rechargeable battery electrically coupled to the charging coil.

8. The inductive charging dock of claim 6, further comprising a power supply port electrically coupled to the charging coil.

9. The inductive charging dock of claim 6, wherein the charging coil is positionable against at least one of a display or a display frame of the AR glasses.

Some example features for an example wearable power device configured to charge a head-mountable device can include:

10. A wearable power device, comprising:
a wearable power supply; and
a power connection positioned on or within the wearable power supply, the wearable power supply being directly attachable to an augmented reality (AR) glasses arm during use or wear of the AR glasses.

11. The wearable power device of claim 10, wherein the power connection comprises a clip-on attachment.

12. The wearable power device of claim 10, wherein the power connection comprises a magnetic attachment.

13. The wearable power device of claim 10, wherein the power connection is sized and shaped to receive an arm tip of the AR glasses arm.

14. The wearable power device of claim 10, wherein the power connection is a conductive power connection.

Some example features for another example wearable power device to charge a head-mountable device include:

15. A wearable power device, comprising:
a wearable power supply;
a first power connection, the first power connection attachable to a first arm of augmented reality (AR) glasses during use or wear of the AR glasses; and
a second power connection, the second power connection attachable to a second arm of the AR glasses arm during use or wear of the AR glasses.

16. The wearable power device of claim 15, further comprising a lanyard, wherein the wearable power supply is coupled to the first power connection and the second power connection via the lanyard.

17. The wearable power device of claim 16, wherein the lanyard is adjustable.

18. The wearable power device of claim 15, wherein the wearable power supply is positionable against a neck or head of a user.

19. The wearable power device of claim 15, wherein:
the first power connection is attachable to an arm tip of the first arm; and
the second power connection is attachable to an arm tip of the second arm.

Some example features for yet another example wearable power device to charge a head-mountable device can include:

20. A wearable power device, comprising:
a wearable power supply;
a power connection positioned on or within the wearable power supply, the wearable power supply being directly attachable to an augmented reality (AR) glasses arm during use or wear of the AR glasses; and
a magnet positioned on or within the wearable power supply.

21. The wearable power device of claim 20, wherein the magnet is engageable with a corresponding magnet positioned on or within the AR glasses.

Some example features for a charging case to charge a head-mountable device include:

22. A charging case, comprising:
a case body sized and shaped to receive augmented reality (AR) glasses, the AR glasses being at least partially exposed when positioned in the case body; and
a charging interface positioned on or within the case body.

23. The charging case of claim 22, wherein the charging interface is positioned inside the rechargeable case.

24. The charging case of claim 22, wherein the charging interface comprises a conductive charging interface engageable with a nose bridge of the AR glasses.

25. The charging case of claim 22, wherein the charging interface is positioned outside the case body, the charging interface comprising a power connection between an exterior portion of the case body and at least one arm of the AR glasses.

The foregoing detailed description used specific language and nomenclature for purposes of explanation and to provide a thorough understanding of the described embodiments. However, the specific details are not required in order to practice the described embodiments. Rather, the foregoing descriptions of the specific examples described herein are presented for purposes of illustration and description and are necessarily not intended to be exhaustive or to limit the embodiments to the precise forms disclosed. In fact, many modifications and variations are possible in view of the above teachings.

What is claimed is:

1. A wearable system, comprising:
a head-mountable device (HMD) comprising:
a display;
a display frame housing the display;
an arm connected to the display frame;
a processor; and
a battery electrically coupled to the processor; and
a power supply connectable to the battery of the HMD when the HMD is worn.

2. The wearable system of claim 1, wherein the power supply is attachable to at least one of the arm or a nose bridge of the display frame.

3. The wearable system of claim 1, further comprising a power connection positioned at an arm tip region of the arm.

4. The wearable system of claim 3, wherein the power supply comprises a clip-on battery connectable to the power connection.

5. The wearable system of claim 3, wherein the power supply comprises:
a rechargeable battery positionable against a neck or head of a user; and
a lanyard connecting the rechargeable battery to the power connection.

6. The wearable system of claim 3, wherein the arm comprises a first arm, the power connection comprises a first power connection, and the arm tip comprises a first arm tip, the wearable system further comprising:
a second arm connected to the display frame; and
a second power connection positioned at a second arm tip region of the second arm, wherein:
the power connection comprises a first conductive power connection on the arm; and
the second power connection comprises a second conductive power connection on the second arm.

7. The wearable system of claim 1, further comprising:
a first magnet positioned on or within the arm; and
a second magnet positioned on or within the power supply.

8. The wearable system of claim 7, wherein the second magnet mates with the first magnet when the arm is folded against the power supply.

9. The wearable system of claim 8, wherein the first magnet and the second magnet are configured to secure an article of clothing between the first magnet and the second magnet.

10. The wearable system of claim 6, wherein the power supply further comprises:
a rechargeable battery pack; and
a tether electrically coupling the rechargeable battery pack to the first arm and the second arm.

11. An apparatus, comprising:
augmented reality (AR) glasses, comprising:
a display;
a display frame housing the display;
a first arm and a second arm, each rotatably connected to the display frame;
a processor disposed in the first arm; and
a battery electrically coupled to the processor, the battery being disposed in the first arm or the second arm; and
a power device connectable to the AR glasses, wherein:
the AR glasses are at least partially exposed when the power device is connected to the AR glasses; and
the power device is a rechargeable power device or an inductive power device.

12. The apparatus of claim 11, wherein the power device comprises a rechargeable case, the rechargeable case comprising:
a charging interface;
an exterior portion; and
an interior portion sized shaped to receive the display frame and the display, the first arm and the second arm extendable out from the interior portion and foldable against the exterior portion.

13. The apparatus of claim 12, wherein the charging interface is positioned inside the rechargeable case.

14. The apparatus of claim 13, wherein:
the display frame comprises a nose bridge; and
the charging interface comprises a conductive charging interface engageable with the nose bridge.

15. The apparatus of claim 13, wherein:
at least one of the display or the display frame comprises charging coils; and
the charging interface comprises an inductive charging interface engageable with the charging coils.

16. The apparatus of claim 12, wherein the charging interface is positioned outside the rechargeable case, the charging interface comprising a power connection between the exterior portion and at least one of the first arm or the second arm.

17. The apparatus of claim 11, wherein the power device comprises an inductive charging dock, the inductive charging dock comprising a docking station, a wireless charging pad, a mobile phone device, a tablet, or a laptop.

18. A system, comprising:
augmented reality (AR) glasses, comprising:
a display;
a display frame housing the display;
a first arm and a second arm each connected to the display frame, the first arm comprising a detachable portion; and
a battery disposed inside the detachable portion; and
a charging device sized and shaped to receive the detachable portion when detached from the first arm.

19. The system of claim 18, wherein the second arm comprises:
an additional detachable portion; and
an additional battery disposed inside the additional detachable portion.

20. The apparatus of claim 18, further comprising an additional detachable portion interchangeable with the detachable portion.
